(19) United States
(12) Patent Application Publication
(10) Pub. No.: US 2015/0189838 A1
(43) Pub. Date: Jul. 9, 2015

(54) PRUNING HEAD AND PORTABLE INSTRUMENT COMPRISING SAME

(71) Applicant: INFACO, Cahuzac Sur Vere (FR)

(72) Inventor: Daniel Delmas, Cahuzac Sur Vere (FR)

(21) Appl. No.: 14/412,460

(22) PCT Filed: Jul. 3, 2013
(86) PCT No.: PCT/FR2013/051575

§ 371 Date: Jan. 2, 2015

(30) Foreign Application Priority Data
Jul. 3, 2012 (FR) 1201879
Jul. 31, 2012 (FR) 1257450

(51) Int. Cl. A01G 3/08

(52) U.S. Cl. CPC A01G 3/08

(57) ABSTRACT

The pruning head (1) includes a rotor (10) in the shape of a shaft, radially bearing flexible or supple elongated pruning elements (11, 11′, 1″). This head is essentially characterized in that each elongated pruning element (11, 11′, 11″) includes, at at least one of the ends of same, and at a distance from the axis of rotation of the rotor (10), a weight (110, 110′, 110″, 110′″) capable of shearing off undesirable growths formed at the foot of vines and other plants.

### TECHNICAL FIELD

This invention belongs to the field of portable equipment used for operations of processing of the grapevine or other row plantings and relates more particularly to a desuckering head that is able to perform cutting operations whose purpose is to clear vine stocks of undesirable fresh shoots or suckers, which are detrimental to the development of the fruit.

### PRIOR ART

Desuckering tools are known from the prior art that consist of several desuckering heads, each of which is comprised of one or more rollers or rotors that carry on their peripheries flexible elongate elements, in the form of straps or wires, that are able, during the rotation of the roller or rotor, to execute a brushing operation and to exert a cutting action as a result of which the vine stocks are cleared of the unwanted fresh shoots. Some of these desuckering heads are carried on board or towed by self-propelled vehicles such as the one that is the object of the patent application EP 1 201 116. Others, such as the one that is the object of FR 2 853 811, are attached at the end of the output shaft of a portable tool.

The characteristic of the desuckering heads is that they have several radial desuckering elements whose points of attachment to the roller or to the rotor which carries them are organized in several equidistant circles centered on the axis of rotation of the roller or the rotor. These desuckering heads thus form rotary brushes whose desuckering elements are deployed radially in relation to the roller or the rotor.

Regardless of their configuration, certain known desuckering heads exhibit the drawback of not being able totally to clear the vine stocks of their fresh shoots. This is essentially due to the fact that, so as not to damage the vine stocks, too much flexibility is imparted to the elongate elements. For this reason, the desuckering action is manifested more as a more or less strong brushing than as an action of cutting the suckers.

Also known from the patent application WO 97/06665 is a cutting device for plants such as grass that comprises an apron that holds, in a circle, several cutting elements in the form of wires or flexible filaments. The rotation of the rotor creates a cutting disk shape. It appears that such an arrangement cannot work for a desuckering operation that must be performed by elements that are able to produce, because of their rotation, a cylindrical cutting envelope.

### SUMMARY OF THE INVENTION

The object of this invention is to remedy the previously mentioned drawback by proposing a desuckering head that is able to cut off all the fresh shoots without thereby damaging the vine stock and to be easy to use.

For this purpose, the desuckering head according to the invention, comprising a rotor that securely holds flexible or pliable elongate elements for desuckering that extend radially in relation to the rotor, is characterized essentially in that each elongate element has, at at least one of its ends and at some distance from the axis of rotation of the rotor, a flyweight that is able to shear off the fresh shoots.

The flyweight has the effect of increasing the inertia of the flexible elongate element and helps to produce a striking action together with a cutting and/or scraping action. The flexibility or pliability of the elongate element makes it possible to absorb the rough spots of the vine stock (knots et cetera) and to avoid any rebound phenomena, which are particularly detrimental to the ease of use. Moreover, this flexibility or pliability makes it easier to cut the suckers as close to the vine stock as possible.

According to another characteristic of the invention, each desuckering elongate element is flexible, whereby the latter can be elastically deformable. Damage to the vine is thus avoided.

According to a practical embodiment, each desuckering elongate element is in the form of an elastically deformable rod.

According to a variant embodiment, each desuckering elongate element is formed by a cable with a circular cross-section.

According to another embodiment of the invention, each desuckering elongate element is pliable and deformable to avoid damaging the vine.

According to a practical embodiment, each desuckering elongate element is formed by a chain having links.

According to another characteristic of the invention, each flyweight is composed of a rigid, metallic sleeve crimped onto the desuckering elongate element.

According to another characteristic of the invention, each flyweight features at least one cutting and/or scraping edge, that is perpendicular to the longitudinal axis of the desuckering elongate element and parallel to the axis of rotation of the rotor of the desuckering head.

This arrangement, in combination with the striking action exerted by the flyweight, helps to improve the action of cutting the suckers.

According to another characteristic of the invention, this cutting or scraping edge is straight. The purpose of this arrangement is to improve the cutting action.

According to another characteristic of the invention, each flyweight features side cutting and/or scraping edges. This arrangement enhances the cutting and/or scraping effect of each flyweight.

According to another characteristic of the invention, each flyweight forms a bulge at an end of the flexible or pliable elongate element.

According to another characteristic of the invention, the flyweight that each desuckering elongate element comprises is parallelepiped in shape.

According to another characteristic form of the invention, each flyweight features a through-hole by which it is attached to the associated desuckering elongate element.

According to another characteristic of the invention, the flyweight consists of a rectangular base, one of whose major surfaces, in the vicinity of the through-hole, is surmounted by a raised portion. The purpose of such an arrangement is to increase the inertia of the flyweight.

According to another characteristic of the invention, each flyweight is hinged by its through-hole to an end link of the corresponding desuckering elongate element.

According to another characteristic of the invention, the flyweights on each side of the rotor are joined. This thus forms a continuous cutting and/or scraping edge of relatively great length, which increases the effectiveness of the desuckering head by creating, owing to the rotation of the rotor, a cylindrical cutting envelope.

According to another characteristic of the invention, the portion of the rotor of the head that securely holds the desuckering elongate elements forms a clamp that is equipped with two jaws opposite one another, separated by a diametral slot that is open at the end, in which the desuckering elongate elements are securely mounted.

According to another characteristic of the invention, each flyweight is composed of a rigid core coated with a mass of synthetic material.

The invention also relates to a desuckering tool that is noteworthy particularly in that it features a drive element mounted at the end of a tubular pole that holds in rotation a drive shaft that is coupled by one of its two ends to the output shaft of the drive element and that at its other end receives in a coupled way a drive sleeve to which the rotor of a desuckering head is attached according to the invention.

### BRIEF SUMMARY OF THE FIGURES AND DRAWINGS

Other advantages, objects and characteristics of the invention will appear on reading the description of a preferred embodiment, which is given by way of nonlimiting example, with reference to the accompanying drawings, in which:

FIG. 1 is a view in perspective of a desuckering head according to the invention,

FIG. 2 is a view in perspective of a desuckering head according to FIG. 1 mounted at the end of a portable desuckering tool,

FIG. 3 is a view in perspective of another embodiment of the desuckering head according to the invention,

FIG. 4 is a view in perspective of a desuckering head according to FIG. 2 mounted at the end of a portable desuckering tool,

FIG. 5 is a view in perspective of a desuckering head according a third embodiment,

FIG. 6 is a view in perspective of a desuckering head according to FIG. 5, mounted at the end of a portable desuckering tool, such as a telescoping pole,

FIG. 7 is a view in perspective of a flyweight according to another embodiment,

FIG. 8 is a view in section of the flyweight according to FIG. 7.

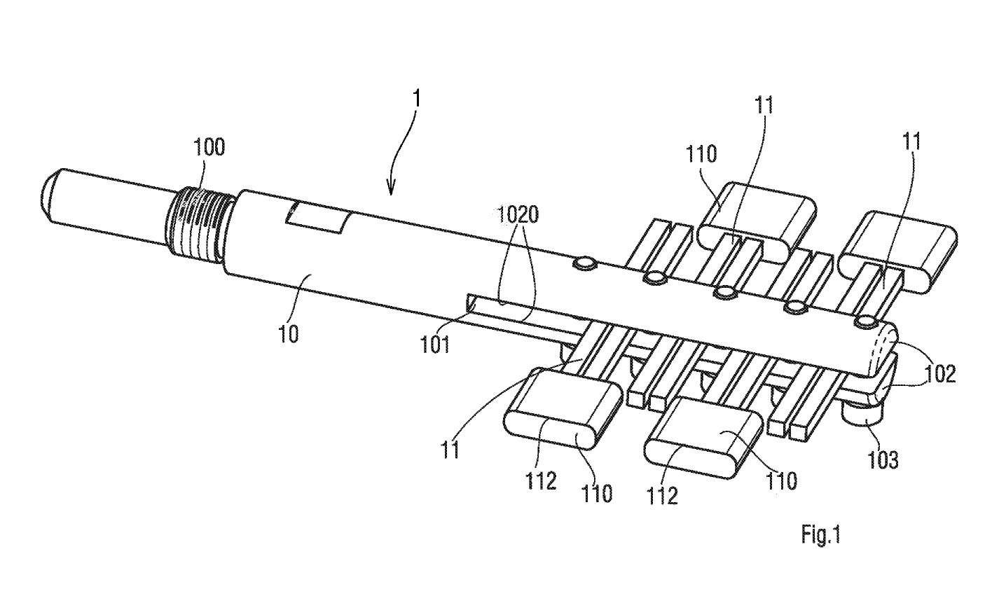

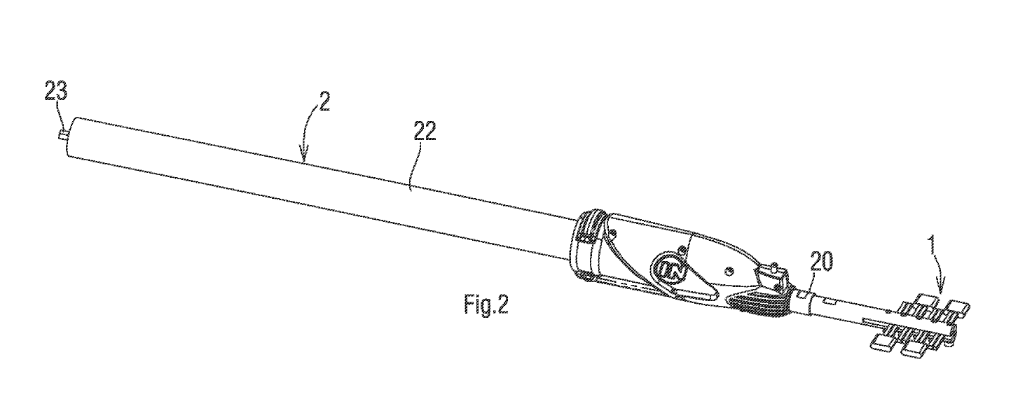

### BEST WAY TO IMPLEMENT THE INVENTION

As shown, the desuckering head (1) according to the invention comprises a rotor (10) that carries radially elongate, deformable and/or pliable and/or flexible desuckering elements (11, 11′, 11″), each of which is equipped, at at least one of their ends and at some distance from the axis of rotation of the rotor, with at least one preferably rigid flyweight (110, 110′, 110″, 110′″) so as to increase the inertia of the elongate element and to form an element for cutting or scraping off the suckers.

These desuckering elements (11, 11′, 11″) are distributed symmetrically relative to the axis of rotation of the rotor (10) so as to balance the masses in rotation and thus avoid any out-of-balance phenomenon. It is also possible for these desuckering elongate elements (11, 11′, 11″) to be arranged in the same diametral plane.

The desuckering head (1) is envisioned to be coupled to the drive sleeve (20), which has a portable desuckering tool (2) of the type for example of those having an electric motor or combustion engine, not shown, mounted at the end of a tubular pole (22) that holds in rotation a drive shaft (23) that is coupled by one of its two ends to the output shaft of the drive element and that holds the drive sleeve (20) coupled at its other end.

Because of the rotation of the head, the desuckering elements, when they are brought against the vine stock to be attended to, are able to strike and shear off the various fresh shoots, which ordinarily appear in the form of buds or vine leaves.

The pole (22) of the desuckering tool, at the opposite end from the desuckering head (1), is provided with a gripping handle that preferably incorporates a trigger for control of the drive element. This pole is long enough for the user to be able to reach the vine stock without having to bend over.

According to a practical embodiment, the rotor (10) of the desuckering head comes in the form of a shaft that is equipped with a threaded end portion (100) which is envisioned to be engaged by screwing into an internal thread made in the drive sleeve (20). At the opposite end of the threaded end portion (100), the rotor (10) is provided with a diametral slot (101) that is open at the end, in which the desuckering elongate elements (11, 11′) are securely mounted. More specifically, the part of the rotor (10) that securely holds the desuckering elongate elements (11) forms a clamp that is equipped with two jaws (102) that are opposite one another and are separated by the diametral slot (101). Transversely across the slot, the clamp is provided with tightening screws (103) that are screwed into internal threads made in one of the jaws (102) and into smooth holes made in the other jaw (102).

Each flexible elongate element (11), according to a first embodiment, is composed of at least one continuous line or rod, or strap, at at least one of the ends of which a flyweight (110) is attached.

Preferably, the elongate element (11) in the form of a line or rod is elastically deformable and is made of a polyamide resin or of any other suitable synthetic material. The elongate element (11) can be reinforced to increase its mechanical strength. With this embodiment, the longitudinal edges (1020) of the jaws (102) are rounded in a radius of a circle that is sufficient to prevent any effect of shearing by the desuckering elongate elements (11) at this level and to facilitate the bending of said desuckering elements (11) at this level as well. This extends the service life of said desuckering elements (11).

Also according to the practical embodiment, the elongate element (11) has a quadrangular cross-section.

In the preferred embodiment, each flyweight (110), which is made of metal, is mounted at the end of two lines or rods (11).

The elongate element (11) as described is mounted in the rotor so that the flyweight (110) is separated from the latter. This distance relative to the axis of rotation, coupled with the degree of flexibility of the line (11), determines the force with which each flyweight (110) strikes the fresh shoots and shears them off. Thus, by adjusting this distance, it becomes possible to adapt the desuckering head (1) to the degree to which the fresh shoots have grown. Thus, for older fresh shoots, with a relatively large diameter, it will be possible to reduce this distance, whereas for young fresh shoots, with a smaller diameter, it will be possible to make this distance larger. To be able to adjust this distance, each elongate element (11) has sufficient reserve length at the opposite end of the rigid flyweight (110).

The flyweight (110) of each elongate element (11) preferably has a mass on the order of 20 to 30 grams.

This flyweight (110) can be parallelepiped in shape, but any other shape can be adopted. Thus, this flyweight can have a cylindrical or spherical shape. Other suitable shapes can be envisaged.

For a parallelepiped-shaped flyweight, the smallest dimension of the parallelepiped will be perpendicular to the geometric diametral plane in which the desuckering elements (11) are deployed.

According to a first practical embodiment, each flyweight (110) is formed from a rigid sleeve, made of, for example, steel or other metal, that is crimped onto the corresponding one or two lines (11). Preferably, the inner surfaces of the metal sleeve, constituting the rigid flyweight (110), are equipped with hooking projections. Such an arrangement is aimed at improving the attaching of the flyweight (110) to the corresponding line(s) (11).

According to the preferred embodiment, each flyweight (110) has at least one cutting and/or scraping edge (112) that is perpendicular to the longitudinal axis of the elongate element (11) and parallel to the axis of rotation of the rotor (10). This cutting edge makes it easier to cut the fresh shoots and other suckers.

Preferably, each cutting edge is straight, but of course any other shape can be imparted to this cutting edge.

Each flyweight (110) can also have lateral cutting and/or scraping edges to enhance the desuckering action.

The flyweights (110), on each side of the rotor (10), can be joined or placed a slight distance apart. Such an arrangement reinforces the action of the desuckering head by forming a continuous cutting or scraping means.

Still according to the preferred embodiment, the flyweight (110) of each desuckering element (11) forms a bulge relative to each corresponding line (11).

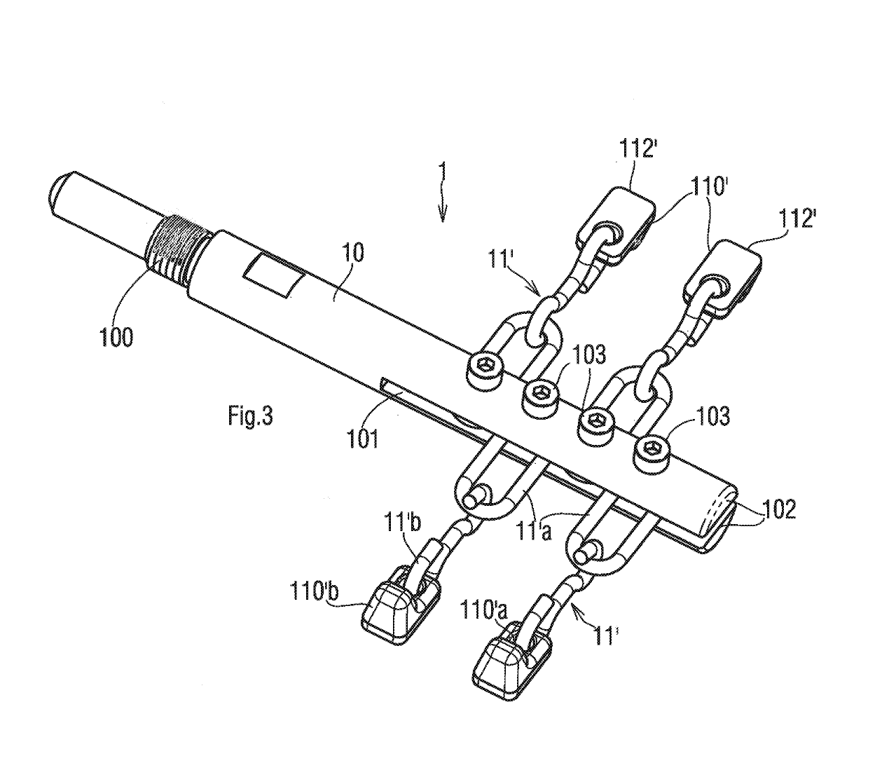

Shown in perspective in FIG. 3 is a second embodiment of a desuckering head according to the invention.

It is clear that this desuckering head still comprises a rotor (10) in the form of a cylindrical shaft that radially carries deformable desuckering elongate elements (11′) each of which is equipped, at at least one of their ends and at some distance from the axis of rotation of the rotor, with at least one flyweight (110′) that is preferably rigid and preferably made of metal. As before, the rotor (10) is provided with a threaded end portion (100) and, at the opposite end, with a diametral slot (101) that is open at the end and that separates two jaws (102) that are opposite one another. Transversely with respect to the slot (101), the clamp is also equipped with tightening screws (103) that are screwed into smooth holes made in one of the jaws (102) and into internal threads made in the other jaw (102).

According to this embodiment, each desuckering element (11′) is formed by a chain having rigid metal links that are interlocked. This chain is attached by one of its links (11′a) between the jaws (102) of the rotor. To reinforce the attachment, this link (11′a) will have the corresponding tightening screw (103) pass through it.

According to the preferred embodiment, this link (11′a) is one of the two end links of the chain (11′), with the other end link (11′b) carrying a flyweight (110′). Alternatively, this link (11′a) can also be the median link of the chain and, in this type of case, said chain is deployed radially on both sides of the rotor (10), and its two end links are each equipped with a flyweight (110′).

The or each flyweight (110′) can be crimped or attached by screw or the like onto the corresponding end link (11′b) but, depending on the preferred embodiment, the end link (11′b) of the chain is open, and the flyweight is provided with a through-hole (110′a) in order to be engaged, through this hole, onto the end link (11′b), leaving a relatively significant operating play. Such an embodiment results in hinging the flyweight (110′) on said link along a geometric axis that is perpendicular to the diametral plane containing the elongate element (11′).

Still according to the preferred embodiment, the constituent chain of each elongate element (11′) comprises only two links (11′a, 11′b), but of course the latter can comprise three or more links.

In the preferred embodiment, the open end link (11′b) consists of a straight base branch that is extended by two rounded, opposite hook shapes. As we see, the median geometric axis of the base branch passes through or near the center of the rounded shape that each hook has. Of course, this link can, just like the link (11′a), be oblong in shape.

Thanks to one of these hook shapes, the open link (11′b) is engaged in the adjacent link (11′a). These two hook shapes will be sufficiently compressed on themselves after mounting to eliminate the risk of separation of the flyweight (110′) and any risk of separation from the adjacent link.

Because of the preceding arrangements, the second end link (11b) is free to pivot relative to the first end link around two geometric axes that are perpendicular to one another, one of which is parallel to the geometric axis of rotation of the rotor (10) and the other of which is perpendicular to the diametral plane in which the elongate elements (11′) are deployed. These arrangements make it possible for each flyweight to be able, upon encountering a hard point on the vine stock, to move aside without the risk of damaging the latter.

Preferably, according to another arrangement of the invention, the flyweight (110′) consists of a rectangular base, one of whose major surfaces, in the vicinity of the hole (110′a), is surmounted by a raised portion (110′b) approximately in the shape of a square-based truncated pyramid. This raised portion (110′b) occupies approximately half of said major surface. The purpose of this raised portion is to increase the inertia of the flyweight (110′).

The surface of the flyweight, opposite the one that holds the raised portion (110′b), has at least one cutting or scraping edge (112′) that is parallel to the axis of rotation of the rotor, with this cutting edge being opposite the hole (110′a). This cutting or scraping edge (112′) can be rounded or can have a sharp edge. The flyweight (110′) can also have lateral cutting or scraping edges.

Likewise, the flyweights (110′) on each side of the rotor (10) can be joined to form one continuous cutting or scraping edge.

Although it is provided to be associated with an elongate element in the form of a chain, this flyweight (110′) can be attached at the end of a desuckering elongate element in the form of a rod as previously described or else, according to another embodiment, at the end of a desuckering elongate element in the form of a multi-line cable, made of, for example, steel and for example with a circular cross section or alternatively at the end of an elongate element in the form of straps, line and the like.

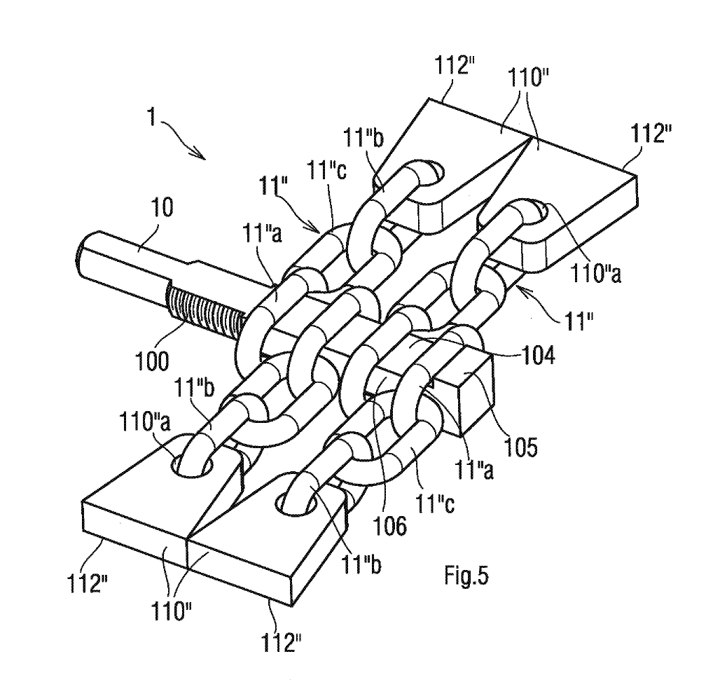

In FIG. 5, a desuckering head according to a third embodiment is shown. The rotor (10), according to this practical embodiment, is always in the form of a shaft equipped with a threaded end portion (100) to be engaged by screwing into an internal thread made in the drive sleeve (20) that comprises the portable tool (2). The deformable elongate elements (11″), with their flyweights, are attached diametrically opposite the rotor (10).

Each deformable elongate element (11″) comes in the form of a chain having closed, rigid, metal links that are interlocked. It can be observed that each link of the chain forms two straight, parallel branches that are joined at the ends by two arched branches, in an arc of a circle. These branches, each with a circular cross section, define an oblong-contour internal space with dimensions, length and width, that are much larger than the diameters of the branches. Such an arrangement allows the links to move in translation inside one another.

The chain (11″) is slipped by one of its two end links (11″a) onto the rotor (10), with the other end link (11″b), or second end link, holding the flyweight (110″). To avoid any rotation of the first end link (11″a) on the rotor (10) and thus to make it possible to drive the elongate element (11″) in rotation, the part of said rotor (10) provided to hold the elements (11″) has two longitudinal flat surfaces (104) that are parallel and diametrically opposite. Moreover, the thickness of the rotor (10), measured between these two flat surfaces, (104) corresponds, aside from operating play, to the inner width of the end link (11″a), measured between its two straight branches. Thus immobilization of the first link of the chain on the rotor in rotation around the longitudinal axis of the latter is established. The flat surfaces (104) are parallel to the axis of rotation of the rotor.

The free end of the rotor (10) (end opposite the threaded tip 100) has a bulge (105) that forms an end stop. This end stop prevents the elongate elements (11″) from slipping off the rotor (10). At the opposite end of the stop, the rotor (10) has a support washer. This support washer is inserted between the drive sleeve (20) and a shoulder of the rotor that is made between the threaded end portion (100) and the part of the sleeve that securely holds the deformable elongate elements (11″). This washer constitutes a stop and prevents the elongate elements (11″) from drifting toward the sleeve (20).

It is evident that, according to this embodiment, the chain (11″) has a single intermediate link (11″c) so that the two end links (11″a) and (11″b) are parallel to one another. Preferably, the first end link (11″a) keeps the corresponding arched branch of the intermediate link (11″c) in contact with or at a very short distance from the rotor (10) and more particularly in contact with or at a very short distance from a flat surface (106) that is formed in the latter perpendicular to the flat surfaces (104). The rotor (10) therefore has two flat surfaces (106) that are diametrically opposite and parallel to one another and are parallel to the axis of rotation of the rotor (10). This arrangement keeps the intermediate link (11″c) from moving along the corresponding arched branch of the first end link (11″a).

Preferably, each flyweight (110″) is rigid, is made of metal, and forms a right-angle prism having two large parallel surfaces and lateral surfaces between these two parallel surfaces. Each major surface of the prism matches the contour of an isosceles trapezoid, and this flyweight (110″), as defined, is provided with a through-hole (110″a) by which it is freely hinged to the second end link (11′b) of the chain. This through-hole (110″a) opens on the two major surfaces of the prism, and its geometric axis is perpendicular to the two major surfaces and is secant to the right bisector that is common to the two parallel sides of each major surface of the flyweight. Also, this hole (110″a) is made near the minor side of each major surface. These arrangements ensure that the center of mass of the flyweight is located far from the chain (11″), which improves the effectiveness of the striking, cutting and scraping actions. It is noted that the two major surfaces of the flyweight (110″) are parallel to the geometric axis of rotation of the rotor (10). As before, such a flyweight has at least one straight cutting or scraping edge (112″), which is parallel to the axis of rotation of the rotor (10), where this cutting edge is formed by the major side of one of the major surfaces of the flyweight. This cutting edge (112″) can be rounded or have a sharp edge. The flyweight (110″) can also have lateral cutting or scraping edges.

The mounting of each flyweight (110″) on the second link of the corresponding chain makes a hinge along a geometric axis that is perpendicular to the diametral plane in which the elongate elements (11″) are deployed. Furthermore, this mounting, which is made with relatively significant operating play, leaves the flyweight (110″) the option of moving along the corresponding arched branch of the second end link (11″b) as well as a limited option of pivoting around a geometric axis that is perpendicular to and intersecting with the geometric axis of rotation of the rotor (10). The second end link (11″b) is free to pivot relative to the intermediate link (11″c) around two geometric axes that are perpendicular to one another, one of which is parallel to the geometric axis of rotation of the rotor (10) and the other of which is perpendicular to the diametral plane in which the elongate elements (11″) are deployed. Because of this arrangement, each flyweight can move aside when it encounters a hard point on the vine stock. Thus, damage to the latter is avoided.

Advantageously, the flyweights located on the same side of the rotor are joined by their major bases so as to form a continuous scraping or cutting line. Such an arrangement greatly improves the desuckering operation.

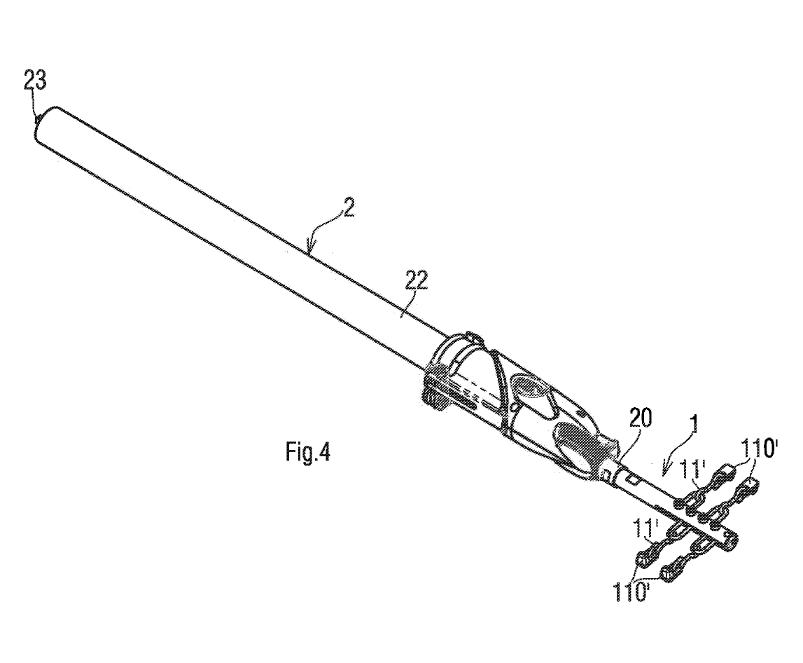

The flyweight as described can be attached at the end of a desuckering elongate element in the form of a rod as previously described or else, according to another embodiment, at the end of a desuckering elongate element in the form a multi-line cable, made of, for example steel and for example with a circular cross section or alternatively at the end of an elongate element in the form of straps, lines and the like. This flyweight can also mounted on an elongate element (11′) similar to the one that is the object of FIGS. 3 and 4. Also, the flyweights (110) and (110′) that are the objects of the first and second embodiments can be mounted on a chain (11″) according to the third embodiment.

The flyweights that comprise the desuckering head can be coated with a synthetic material, for example a 6.6 fiberglass-charged polyamide at a level of 34%, for example. Such an arrangement reduces the risks of damaging the vine stock. Such flyweights are mainly used for desuckering young vines whose stocks still exhibit a certain pliability and a certain fragility. Such flyweights can also be used at the beginning of a desuckering season when the vine leaves or suckers are still young shoots, which are easier to remove on young vines than on old vines.

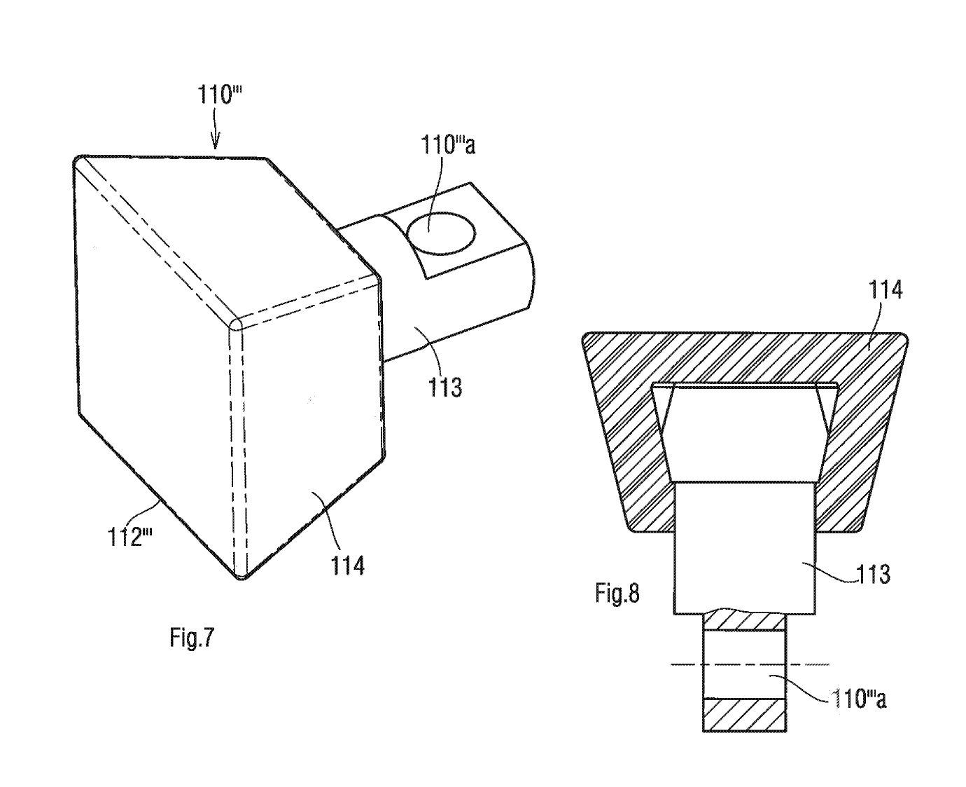

In FIG. 7 an embodiment of a flyweight (110′) with synthetic material coating is shown. This flyweight has a rigid core (113), for example made of steel, coated with a synthetic material forming a desuckering mass (114), in the shape of a square-based truncated pyramid. The core (113) advantageously consists of a cylindrical rod and of a head that is made at one of the ends of the cylindrical rod and forms a raised surface around the latter. This raised surface constitutes, on the one hand, an additional mass that tends to move the center of mass of the flyweight away from the axis of rotation of the rotor (10). On the other hand, this head constitutes an element for hooking and holding the desuckering mass. At the opposite end of the head, the rod has a diametral through-hole (110′″a) by which the flyweight is hinged to its elongate element (11), (11′), or (11″). The desuckering mass (114) partly covers the rod of the core (113) and totally covers the head of the latter. The purpose of these arrangements is to make a flyweight that has a coating that is non-aggressive to the vines, but is reinforced by a metal core. Preferably, the coating or desuckering mass will have a Shore D hardness of 80.

Such a flyweight has at least one scraping edge (112′) formed by one of the sides of the major base of the desuckering mass, with this side being parallel to the axis of rotation of the rotor. As previously indicated, the flyweights (110′) will be mounted joined to form continuous scraping edges.

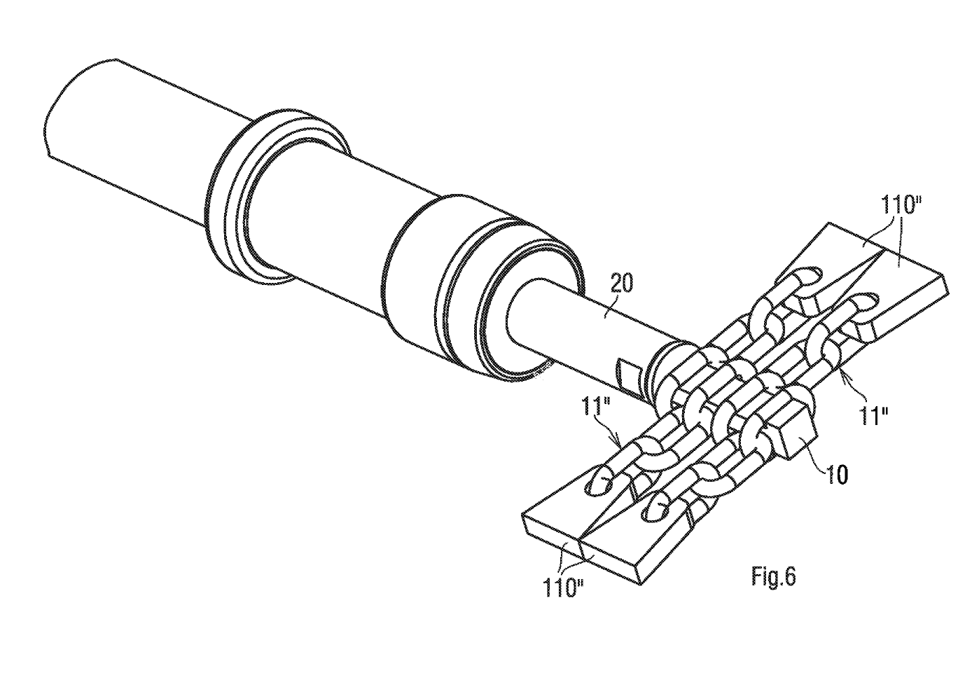

The flyweight as described can be attached at the end of a desuckering elongate element in the form of a rod as previously described or else, according to another embodiment, at the end of a desuckering elongate element in the form of a multi-line cable made of, for example steel and for example with a circular cross section or alternatively at the end of an elongate element in the form of straps and the like. This flyweight can also be mounted on an elongate element (11′), (11″) similar to the one that is the object of FIGS. 3, 4 and 5, 6. Also, the same desuckering head can hold flyweights of various shapes and types as well as elongate elements of various types and shapes.

The desuckering head according to the invention can be used both with portable tools and with desuckering machines of the on-board or towed type.

Of course, this invention can be given any arrangements and variants of the field of technical equivalencies without thereby exceeding the scope of this invention as defined by the following claims.

1. Desuckering head (1) comprising a rotor (10) in the form of a shaft that securely holds desuckering elongate elements (11, 11′, 11″) that extend radially in relation to the rotor, wherein each elongate element, at at least one of its ends and at some distance from the axis of rotation of the rotor (10), comprises a flyweight (110, 110′, 110″, 110′″) that is able to shear off the fresh shoots.

2. Desuckering head (1) according to claim 1, wherein each elongate element (11) is flexible.

3. Desuckering head according to claim 2, wherein each elongate element (11) is in the form of an elastically deformable rod.

4. Desuckering head according to claim 2, wherein each elongate element (11) is formed by a cable with a circular cross section.

5. Desuckering head (1) according to claim 1, wherein each elongate element (11′, 11″) is pliable or deformable.

6. Desuckering head (1) according to claim 5, wherein each elongate element (11′, 11″) is formed by a chain with rigid links that have two end links, one of which, the link (11a, 11′a), is attached to the rotor (10) and the other of which, the link (11b, 11′b) holds a flyweight.

7. Desuckering head (1) according to claim 1, wherein each flyweight (110, 110′, 110″) has at least one cutting and/or scraping edge (112, 112′, 112″) that is perpendicular to the longitudinal axis of the elongate element (11, 11′, 11″) and parallel to the axis of rotation of the rotor (10).

8. Desuckering head (1) according to claim 7, wherein the cutting edge (112, 112′, 112″) is straight.

9. Desuckering head (1) according to claim 7, wherein each flyweight (110, 110′, 110″) has lateral cutting and/or scraping edges.

10. Desuckering head (1) according to claim 1, wherein each flyweight (110) consists of a rigid metal sleeve that is crimped onto the elongate element (11, 11′).

11. Desuckering head (1) according to claim 1, wherein each flyweight (110, 110′) forms a bulge relative to the corresponding elongate element (11, 11′).

12. Desuckering head (1) according to claim 1, wherein each flyweight (110) is parallelepiped in shape.

13. Desuckering head (1) according to claim 1, wherein each flyweight (110′, 110″, 110′″) has a through-hole by which it is attached to the associated elongate element (11, 11′, 11″).

14. Desuckering head (1) according to claim 6, wherein each flyweight has a through-hole by which it is attached to the associated elongate element, and the flyweight (110′, 110″) is hinged by its through-hole to an end link (11′b, 11″b) of the associated elongate element (11′, 11″).

15. Desuckering head (1) according to claim 14, wherein each flyweight (110′) consists of a rectangular base, one of the major surfaces of which, in the vicinity of the through-hole (110′a), is surmounted by a raised portion (110′b).

16. Desuckering head according to claim 1, wherein the portion of the rotor (10) that firmly holds the desuckering elongate elements (11, 11′) forms a clamp equipped with two jaws (102) that are opposite one another and are separated by a diametral slot (101) that is open at the end, in which the desuckering elongate elements (11, 11′) are securely mounted.

17. Desuckering head (1) according to claim 16, wherein the longitudinal edges (1020) of the jaws (102) are rounded to prevent any effect of shearing by the desuckering elongate element (11) at this level and also to facilitate the bending of said desuckering element (11) at this level.

18. Desuckering head (1) according to claim 6, wherein the portion of said rotor (10) provided to hold the elements (11″) has two longitudinal flat surfaces (104) that are parallel and diametrically opposite and the thickness of the rotor (10), measured between these two flat surfaces (104), corresponds, aside from operating play, to the inner width of the end link (11″a), measured between its two straight branches.

19. Desuckering head (1) according to claim 18, wherein each flyweight forms a right-angle prism that has two major parallel surfaces and lateral surfaces between these two parallel surfaces, each major surface of the prism matches the contour of an isosceles trapezoid and the through-hole (110″a) by which it is freely hinged to the second end link (11″b) of the chain is made near the minor side of each major surface.

20. Desuckering head (1) according to claim 1, wherein each flyweight consists of a rigid core coated with a mass of synthetic material.

21. Desuckering head (1) according to claim 14, wherein each flyweight (110′″) has a rigid core (113) that is coated with a synthetic material, forming a desuckering mass (114), in the form of a square-based truncated pyramid, the core consists of a cylindrical rod and a head made at one of the ends of the cylindrical rod and forming a raised surface around the latter, at the opposite end of the head, the rod has a diametral through-hole (110′″a) by which the flyweight is hinged to its elongate element (11), (11′), or (11″) and the desuckering mass (114) partly covers the rod of the core and totally covers the head of the latter.

22. Desuckering head (1) according to claim 1 further comprising several desuckering elements (11, 11′, 11″) arranged in the same plane that is diametral to the rotor and the flyweights (110, 110′, 110″, 110′″) of the elements located on the same side of the rotor (10) are joined.

23. Desuckering tool (2), comprising a drive element mounted at the end of a tubular pole (22) that holds in rotation a drive shaft (23) that is coupled by one of its two ends to the output shaft of the drive element and at its other end receives in a coupling way a drive sleeve (20) to which the rotor (10) of a desuckering head is attached according to claim 1.
